(19) United States
(12) Patent Application Publication
(10) Pub. No.: US 2025/0051168 A1
(43) Pub. Date: Feb. 13, 2025

(54) PROCESS FOR PRODUCING GRAPHITE AND VERTICAL GRAPHITIZATION FURNACE

(71) Applicant: ONEJOON GMBH, Bovenden (DE)

(72) Inventors: Matthias Muck, Adelebsen (DE); Petrus Jacobus Vervoort, Bovenden (DE)

(21) Appl. No.: 18/928,395

(22) Filed: Oct. 28, 2024

Related U.S. Application Data
(62) Division of application No. 17/764,310, filed on Mar. 28, 2022.

(30) Foreign Application Priority Data
Sep. 30, 2019 (DE) 10 2019 126 394.8

(51) Int. Cl. C01B 32/205; F27B 1/00; F27B 1/21

(52) U.S. Cl. CPC C01B 32/205; F27B 1/005; F27B 1/21; C01P 2004/61

(57) ABSTRACT

A process for producing graphite in a vertical graphitization furnace having at least one process chamber that bounds a heating zone, a temperature of 2200° C. to 3200° C. is generated in the heating zone, particulate graphitizable material is supplied to the process chamber through an inlet, graphitizable material is conveyed through the heating zone of the process chamber, in which it is graphitized to graphite, and graphite obtained is removed from the process chamber through an outlet. In some variants, graphitizable material wherein the particles have a particle size of less than 3 mm is used, and/or, a material column is formed throughout the heating zone of a particular process chamber, wherein graphitizable material, after being supplied through the inlet from the top, trickles through an intake zone of the process chamber onto the material column, and/or, a material column is formed in a stationary heating zone of a particular process chamber encompassed by the heating zone, wherein graphitizable material, after being supplied through the intake from the top, trickles through a drop heating zone likewise encompassed by the heating zone onto the material column, and/or, graphitizable material in one or more material vessels is conveyed through a particular process chamber and through the heating zone thereof. Also specified is a vertical graphitization furnace optimized.

### RELATED APPLICATIONS

The present application is a division of U.S. patent Ser. No. 17/764,310 filed Mar. 28, 2022, which is a § 371 national phase of International Pat. App. No. PCT/EP2020/073932 filed Aug. 27, 2020, which claims the filing benefit of German Pat. App. No. 10 2019 126 394.8 filed Sep. 30, 2019—the contents of all of which are expressly incorporated herein by reference.

### BACKGROUND OF THE INVENTION

### 1. Field of the Invention

The invention relates to a process for producing graphite in a vertical graphitization furnace having at least one process space which delimits a heating zone, in which
a) a temperature of from 2200° C. to 3200° C., in particular of from 2700° C. to 3200° C., preferably of 3000° C., is generated in the heating zone;
b) particulate graphitizable material is fed through an entrance into the process space;
c) graphitizable material is conveyed through the heating zone of the process space, in which it is graphitized to give graphite;
d) graphite obtained is discharged from the process space through an exit.

The invention further relates to a vertical graphitization furnace having at least one process space which delimits a heating zone, comprising
a) a heating device by means of which a temperature of from 2200° C. to 3200° C., in particular of 3000° C., can be generated in the heating zone;
b) a feed conveyor by means of which particulate graphitizable material can be fed through an entrance into the process space;
where
c) graphitizable material can be conveyed through the heating zone of the process space, in which it is graphitized to give graphite;
d) an output conveyor is present, by means of which graphite obtained can be discharged from the process space through an exit.

### 2. Description of the Prior Art

The graphitization of graphitizable material is carried out in an inert gas atmosphere. It is known that polycrystalline graphite, which is used for anode material, can be produced in batch processes in so-called Acheson furnaces in which graphitizable material is graphitized to give graphite.

In addition, graphitizing graphitizable material having large particle diameters of more than 3 mm in vertical graphitization furnaces of the type mentioned at the outset to give graphite is known from EP 2 980 017 B1. After this process, the graphite obtained, which has particles which are too large for anode material, has to be comminuted to give a graphite powder.

### SUMMARY OF THE INVENTION

It is an object of the invention to provide a process and a vertical graphitization furnace of the type mentioned at the outset which are energy-efficient and make a largely constant and reproducible graphite quality possible.

This object is achieved in a process of the type mentioned at the outset by,
as variant A, graphitizable material whose particles have a particle size of less than 3 mm being used;
and/or
as variant B, a column of material being formed in the total heating zone of a particular process space, with graphitizable material which has been fed in through the entrance trickling from the top through an inlet zone of the process space onto the column of material;
and/or
as variant C, a column of material being formed in a standing heating zone of a particular process space, said standing heating zone being encompassed by the heating zone, and graphitizable material which has been fed in through the entrance trickling from the top through a falling heating zone, which is likewise encompassed by the heating zone, onto the column of material;
and/or
as variant D, graphitizable material being conveyed in one or more containers for material through a particular process space and through the heating zone thereof.

It has been recognized according to the invention that the above object is achieved in the process of the type mentioned at the outset by means of a number of approaches which, when employed either alone or in a synergistic combination or, if a graphitization furnace having a plurality of process spaces is utilized, in parallel, contribute to a more effective process procedure compared to the prior art. Since variants A, B, C and D can also be carried out in parallel, mention may in each case be made in the case of variants B, C and D and in the following of a “particular” process space. This is intended to express the fact that in the case of optionally a plurality of process spaces in a furnace, one particular process space is under consideration. This can also be, but does not have to be, a process space in which another variant proceeds, as long as these can proceed simultaneously; this is not possible in the case of variants B and C.

Variant A makes it possible, in the most favorable case, to dispense with a subsequent comminution of the graphite obtained. In any case, the outlay for satisfactory comminution can be reduced.

Variant B allows a continuous process in a defined atmosphere.

In variant C, a type of preheating can occur in the falling heating zone, so that the energy consumption for heating the column of material which is then formed from the already preheated graphitizable material is reduced.

In variant D, smaller volumes are graphitized in the containers for material, as a result of which process control is improved.

To achieve a constantly controllable process, it is advantageous for the same volume of graphitizable material to be fed into a particular process space per unit of time as the volume of graphite which is discharged from this process space per unit of time.

The graphitizable material can be fed continuously or intermittently into a particular process space and graphite can be discharged continuously or intermittently from this process space, with preference being given to continuous feeding and discharge. In the case of an intermittent process, feeding and discharge can be carried out simultaneously or offset in time.

In order to carry out process variants B and C reproducibly, it is advantageous for a fill level of the column of material to be kept largely constant in the case of variant B and/or in the case of variant C.

To control and monitor the preheating in the case of variant C, it can be advantageous for a gas to be blown in countercurrent opposite to or in a flow in the falling direction of the graphitizable material into the falling heating zone.

As already indicated above, it is possible to use a graphitization furnace which has a plurality of process spaces and whose plurality of process spaces are operated in parallel in time.

In respect of variant A, it is advantageous for the particles of the graphitizable material to have an average particle diameter of greater than 5 μm and less than 3000 μm, less than 2500 μm, less than 2000 μm, less than 1500 μm, less than 1000 μm or less than 500 μm, or in that the particles of the graphitizable material to have an average particle diameter of from 5 μm to 3000 μm, from 500 μm to 2000 μm or from 1000 μm to 1500 μm.

For effective operation, it is advantageous for the temperature of the heating zone to be determined, in particular at the upper end of the heating zone and/or in approximately the middle of the heating zone and/or at the lower end of the heating zone and/or at the column of material of each process tube present. In this way, account can quickly be taken of temperature fluctuations in the heating zone by controlling the heating device in such a way that undesirable temperature changes are compensated for.

In the vertical graphitization furnace of the type mentioned at the outset, the object indicated is achieved by
e) the heating zone in at least one process space comprising a falling heating zone and a standing heating zone which are configured such that a column of material is formed in the standing heating zone and graphitizable material which has been fed in through the entrance can trickle from the top through the falling heating zone onto the column of material;
and/or
f) a transport system being present, by means of which graphitizable material can be conveyed in one or more containers for material through at least one process space and through the heating zone thereof.

This optimizes the graphitization furnace, especially in respect of process variants C and D.

In this case, it is advantageous in the transport system for the feed conveyor and the output conveyor to be configured in such a way that they transport containers for material containing material, and for the transport system to comprise a process space conveyor which is configured in such a way that it conveys containers for material from the entrance to the exit.

The vertical graphitization furnace can be operated particularly effectively when the transport system is a loop transport system and additionally comprises a connecting conveyor by means of which containers for material can be conveyed from the output conveyor to the feed conveyor.

The containers for material are advantageously crucibles having a crucible lid.

As explained above, it is advantageous for a plurality of process spaces to be present in the graphitization furnace.

Furthermore, a temperature monitoring device is advantageous, by means of which it is possible to determine the temperature of the heating zone, in particular at the upper end of the heating zone and/or in approximately the middle of the heating zone and/or at the lower end of the heating zone and/or at the column of material of each process tube present.

### BRIEF DESCRIPTION OF THE DRAWINGS

Exemplary embodiments of the invention will be explained in more detail below on the basis of the drawings, in which:

FIG. 1 shows a vertical graphitization furnace according to a first exemplary embodiment in which graphitizable material is conveyed as column of material from the top downward through a process space, illustrating a first way of carrying out the process;

FIG. 2 shows the vertical graphitization furnace of FIG. 1, illustrating a second way of carrying out the process;

FIG. 3 shows a vertical graphitization furnace according to a second exemplary embodiment having two process spaces which run parallel;

FIG. 4 shows a modification of the exemplary embodiment of FIG. 3, in which the process spaces which run parallel are at a distance from one another;

FIG. 5 shows a vertical graphitization furnace according to a third exemplary embodiment having a transport system for containers for material in which graphitizable material is located.

### DESCRIPTION OF PREFERRED EXEMPLARY EMBODIMENTS

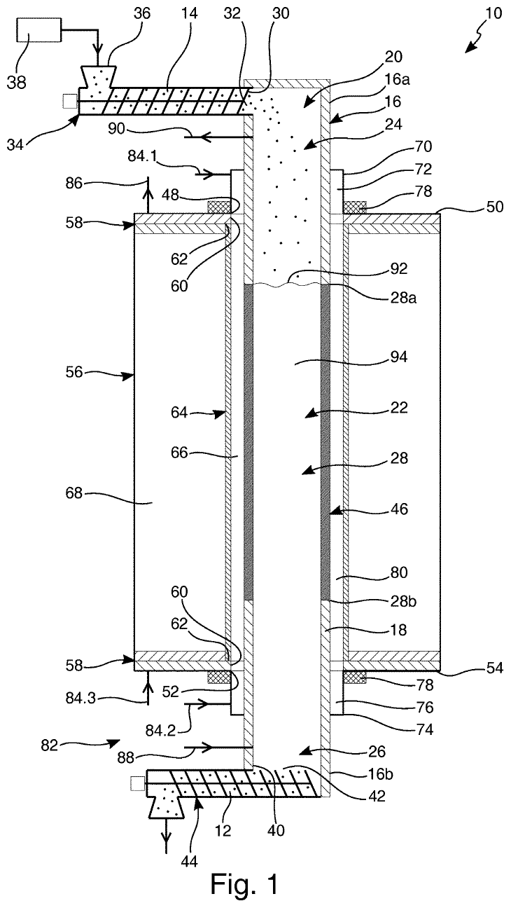

FIG. 1 shows a vertical graphitization furnace 10 which is used for producing polycrystalline graphite 12 for anode material and will subsequently be referred to merely as furnace 10. Particulate graphitizable material 14 serves as starter material for the production of the polycrystalline graphite 12. Graphitizable materials contain carbon, with conversion of amorphous carbon into polycrystalline graphite occurring during graphitization. Examples of graphitizable materials are brown coal or hard coal and optionally also polymers.

The particles of the graphitizable material 14 preferably have a particle size of less than 3 mm. The particles of the graphitizable material 14 preferably have an average particle diameter of greater than 5 μm and less than 3000 μm, less than 2500 μm, less than 2000 μm, less than 1500 μm, less than 1000 μm or less than 500 μm. As an alternative, the particles can have an average particle diameter of from 5 μm to 3000 μm, from 500 μm to 2000 μm or from 1000 μm to 1500 μm.

The furnace 10 comprises a process tube 16 having an outer tube wall 18 made of graphite, which in its interior space 20 accommodates a process space 22 which delimits an inlet zone 24 arranged vertically at the top, an outlet zone 26 arranged vertically at the bottom and a heating zone 28 which is arranged in between and in which the particles of the graphitizable material 14 are graphitized to give graphite 12.

The upper end 28a of the heating zone 28 is thus defined at the transition of the inlet zone 24 to the heating zone 28; the lower end 28b of the heating zone 28 is correspondingly defined at the transition of the heating zone 28 to the outlet zone 26. The interior space 20 or the process space 22 preferably have a circular cross section. However, alternative cross sections, for example elliptical or square or rectangular, are also possible. In general, the outer tube wall 18 displays the geometry of the cross section of the interior space 20 or of the process space 22 and has a corresponding outer cross section; however, this can also be different therefrom.

The inlet zone 24 of the process tube 16 is joined at an entrance 30 to an exit side 32 of a feed conveyor 34 for the graphitizable material 14, the entrance side 36 of which is supplied with the graphitizable material 14 from a reservoir 38 for material. In the present exemplary embodiment, the feed conveyor 34 is configured such that it conveys the graphitizable material 14 as such and is for this purpose configured, in particular, as screw conveyor, as is known per se. The outlet zone 24 of the process space 22 is correspondingly joined at an exit 40 to an entrance side 42 of an output conveyor 44 by means of which the graphite 12 produced is taken off from the outlet zone 26 and discharged. In the present exemplary embodiment, the output conveyor 44 is configured such that it conveys the graphite 12 as such, for which purpose the output conveyor 44 is likewise configured as screw conveyor. However, this is additionally cooled with the aid of a water cooling system, as is however likewise known per se.

The feed conveyor 34 and the output conveyor 44 are configured in such a way that a gastight connection to the process tube 16 can be formed and transport can also be effected with exclusion of the ambient atmosphere. Alternative transport concepts, such as for example star feeders, double flap systems in combination with, for example, a conveyor belt or a vibratory chute or the like, are also possible for this purpose.

In the region of the heating zone 28, the process space 16 is heated to from about 2200° C. to about 3200° C., preferably to about 3000° C., by means of a heating device 46 for the graphitization process, which is indicated in the figures merely by the darker hatched region of the process tube 16. The heating device 46 is in practice an electric heating device. For example, the wall thickness of the process tube 16 is for this purpose reduced in the region of the heating zone 28, so that the process tube 16 is more effectively heated up there due to the higher electrical resistance. The heating zone 28 is defined by a contiguous section of the process space 22, in which essentially the same graphitization temperature prevails.

The process tube 16 extends through a through-opening 48 of an upper covering wall 50 and through a through-opening 52 of a lower bottom wall 54 of an insulating housing 56 made of, for example, steel sheet, in such a way that an upper end section 16a of the process tube 16 projects in an upward direction and a lower end section 16b of the process tube 16 projects in a downward direction from the insulating housing 56. On the inside of the covering wall 50 and the bottom wall 54, there are arranged in each case plate-shaped insulation elements 58, preferably made of hard graphite felt, with a passage 60 which is stepped in the axial direction for the process tube 16, which in each case define a step area 62. The respective region of the stepped passage 60 having a smaller cross section is directed toward the covering wall 50 or the bottom wall 54 of the insulating housing 56, so that the step areas 62 face one another. The insulation elements 58 can be made in one piece or be formed by two plate-shaped elements which have through-openings having different diameters, so that the stepped passage 60 is formed overall.

A protective housing 64 made of graphite, for example a protective tube, for the process tube 16 extends from the step area 62 of the insulation element 58 on the covering wall 50 to the step area 62 of the insulation element 58 on the bottom wall 54 in such a way that an annular space 66, which is open at the top and bottom in the direction of the through-openings 48 and 52 of the covering wall 50 and the bottom wall 54, respectively, is formed between the process tube 16 and the protective housing 64.

An insulating annular space 68, which is bounded by the protective housing 64, the insulating housing 56 and the insulation elements 58, is formed radially next to the protective housing 64. This insulating annular space 68 is filled with carbon black in the present exemplary embodiment.

The through-opening 48 of the covering wall 50 is covered by means of an upper connection cap 70. In the present exemplary embodiment, the upper end section 16a of the process tube 16 extends through the upper connection cap 70, so that an upper annular connection space 72 is formed between the covering wall 50 of the insulating housing 56 and the entrance 30 of the process tube 16; this annular connection space 72 is fluidically connected via the through-opening 48 and covering wall 50 and the passage 60 of the upper insulation element 58 to the annular space 66.

In a corresponding way, the through-opening 52 of the bottom wall 54 is covered by means of a lower connection cap 74. In the present exemplary embodiment, the lower end section 16b of the process tube 16 extends through the lower connection cap 74, so that a lower annular connection space 76 is formed between the bottom wall 54 of the insulating housing 56 and the exit 40 of the process tube 16; this annular connection space 76 is in turn fluidically connected via the through-opening 52 of the bottom wall 54 and the passage 60 of the lower insulation element 58 to the annular space 66.

At the upper and lower transitions between the insulating housing 56 and the connection caps 70 and 74, there is a housing cooling device 78 to protect the housing components, which is designed as a water cooling system, as is known per se.

The annular connection spaces 72 and 76, the annular space 66 and the passages 60 of the insulation elements 58 form a gas space 80 which is part of a protective gas system 82.

The protective gas system 82 further comprises a first protective gas inlet connection 84.1 on the upper connection cap 70 and a second protective gas inlet connection 84.2 on the lower connection cap 74, through which a protective gas can be blown into the gas space 80.

Since the insulation elements 58 are porous and thus gas-permeable, protective gas diffuses from the gas space 80 in the regions of the passages 60 having a smaller cross section into the insulation elements 58 and further into the insulating annular space 68. At the covering wall 50 of the insulating housing 56, there is a protective gas outlet connection 86 so that the protective gas can be discharged. To assist, a third protective gas inlet connection 84.3 is also present on the bottom wall 54 of the insulating housing 56, so that protective gas can also be blown in a targeted manner into the insulating annular space 66.

The protective gas around the process tube 16 is necessary because the graphitization of the graphitizable material 12 occurs under an inert gas atmosphere which is present in the process space 22. As protective gas, use is generally made of the same gas as the inert gas, so that the same type of gas is present on both sides of the outer tube wall 18 of the process tube 16. However, different gases can also be used as protective gas and as inert gas, it being necessary for the protective gas to also be inert. For example, argon, nitrogen or helium or a mixture thereof can be used as protective gas and/or as inert gas.

In order to then introduce inert gas into the process space 22, the process tube 16 is coupled at the lower end section 16b to an inert gas inlet connection 88 through which the inert gas can be blown into the process space 22. The upper end section 16a of the process tube 16 is connected to an offgas outlet connection 90, so that gases formed in the graphitization mixed with inert gas can be drawn off as offgas from the process space 22. In this case, the furnace 10 is thus operated in countercurrent, with the inert gas flowing through the process space 22 in the opposite direction to the direction of movement of the material present in the process space 22. As an alternative, the inert gas inlet connection 88 can be arranged at the upper end section 16a of the process tube 16 and the offgas outlet connection 90 can be arranged at the lower end section 16b of the process tube 16. In a further modification, in each case an inert gas inlet connection and an offgas outlet connection can be connected to the process space 22 both at the top and at the bottom, so that the graphitization can optionally be carried out in countercurrent or in cocurrent by appropriate switching-over. The offgas is in each of these cases passed to thermal after-combustion, as is known per se.

In a further modification, a gas supply tube can lead from an inert gas inlet connection 88 arranged at the upper end section 16a in a downward direction to just above the fill level 92 of the column of material 94, so that inert gas is blown into the process space 22 there above the column of material 94.

Transport components such as blowers, gas pumps and the like required for transport of protective gas, inert gas or offgas and associated conduits and also control devices are not individually shown in the interest of simplicity.

The furnace 10 is then operated as follows:

Before first start-up, the process space 22 and the process space atmosphere present there firstly have to be freed of oxygen and moisture, in particular due to air present. For this purpose, the process space 22 is flushed with the inert gas and the gas space 80 and also the insulating annular space 68 are flushed with protective gas.

The heating device 46 is activated, and graphitizable material 14 is fed into the process space 22 to a fill level 92 by means of the feed conveyor 34. When the output conveyor 44 is then activated, this firstly conveys incompletely reacted material out of the process space 22 until graphite 12 obtained in the heating zone 28 reaches the output conveyor 44.

In the ongoing graphitization process, graphitizable material 14 is continuously fed into the process space 22 by means of the feed conveyor 34 and graphite 12 obtained therefrom is continuously removed from the process space 22 by means of the output conveyor 44. Here, the same volume of graphitizable material 14 is fed in per unit of time, for example per minute, as the volume of graphite 12 which is discharged per unit of time, i.e. possibly per minute, so that the fill level 92 in the process tube 92 remains largely constant. The furnace 10 viewed overall in terms of material management is thus operated continuously here.

In a modification, the furnace 10 is, viewed overall in terms of material management, operated intermittently. In this case, graphitizable material 14 is, with simultaneous feeding and discharge, continuously fed into the process space 22 by means of the feed conveyor 34 and graphite 12 obtained therefrom is continuously removed at the same time from the process space 22 by means of the output conveyor 44 when a material replacement operation in which a particular volume of graphite 12 is taken off and replaced by a corresponding volume of graphitizable material 14 is carried out.

In continuous furnace operation, the conveying speeds of the feed conveyor 34 and of the output conveyor 44 are in any case set such that the residence time of the graphitizable material 14 in the heating zone 28 at about 3000° C. is from about 2 to 3 hours. Graphite 12 which is no longer mixed with graphitizable material may in this case already be present in a lower region of the heating zone 28.

At a temperature in the heating zone 28 of about 2700° C., the residence time of the graphitizable material 14 can be from about 10 to 20 hours.

FIG. 1 illustrates a process procedure in which the fill level 92 in the process tube 16 corresponds to the height level of the upper end 28a of the heating zone 28. In other words, a column of material 94 which extends from the fill level 92 downward and also through the outlet zone 26 to the exit 40 of the process tube 16 is formed in the total heating zone 28. The inlet zone 24, by contrast, is passed through only by graphitizable material 14 which, after having been fed through the entrance 30 into the process space 22, trickles from the top through the inlet zone 24 onto the column of material 94 and then becomes part of the column of material 94. The term trickling is intended here as a general term for the material falling downward without any relationship to possible technical parameters such as flowability of bulk materials or the like.

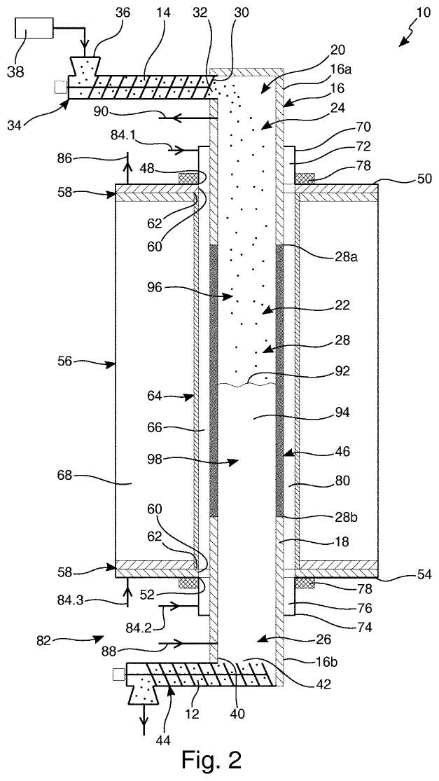

FIG. 2 illustrates an alternative way of carrying out the process, in which the fill level 92 is located below the upper end 28a of the heating zone 28. The column of material 94 is thus not formed in the total heating zone 28. Rather, a falling heating zone 96, in which graphitizable material 14 enters at the top from the inlet zone 24 and trickles or falls further through the falling heating zone 94 onto the column of material 94, and then arrives on the column of material 94 and becomes part of the latter, is formed between the column of material 94, i.e. the fill level 92, and the upper end 28a of the heating zone 28. The falling heating zone 94 is thus passed through by the graphitizable material 14 while falling or when falling from the top downward.

In the mode of operation described here, the falling heating zone 96 is a type of free-fall heating zone which is passed through by the graphitizable material 14 in free fall from the top downward. Here, the countercurrent flow of the atmosphere in the process tube 16 in the direction of the offgas outlet connection 90 can retard the falling of the particles of the graphitizable material 14 compared to a free fall and can thus increase the residence time in the falling heating zone 96. In the modification discussed above, in which the offgas outlet connection 90 is provided at the bottom of the process tube 16, the gas stream can consequently accelerate the falling of the particles of the graphitizable material compared to a free fall and thereby reduce the residence time in the falling heating zone 96.

In modifications which are not shown individually, inert gas can optionally be blown in countercurrent against or in a flow in the falling direction into the falling heating zone 96 in a targeted manner in order to deliberately retard or accelerate the speed of falling of the particles of the graphitizable material 14 in order to set the residence time in the falling heating zone 96 in a targeted manner.

That region of the heating zone 28 in which the column of material 94 is formed defines a standing heating zone 98 which is encompassed by the heating zone 28. The term “standing” is merely intended to indicate that the column of material 94 as such is present largely stationary, even though the column of material 94 is altered due to the introduction of material and discharge of material during operation of the furnace 10. At least essentially the same temperature prevails in the falling heating zone 94 and in the standing heating zone 98.

In the falling heating zone 94, the graphitizable material 14 is already heated while it trickles in and reaches the column of material 94 already with a higher initial temperature than in the case of a column of material 94 having a fill level 92 at the upper end 28a of the heating zone 28. As a result, particles of the graphitizable material 14 attain the temperature necessary for graphitization more quickly.

In the variant shown in FIG. 2, the falling heating zone 96 and the standing heating zone 98 each cover about 50% of the heating zone 28. In practice, effective graphitization was able to be achieved in a furnace 10 in which the falling heating zone 96 covers from 10% to 60%, preferably from 20% to 55%, more preferably from 30% to 50%, in particular 30% or the illustrated 50%, of the heating zone 28.

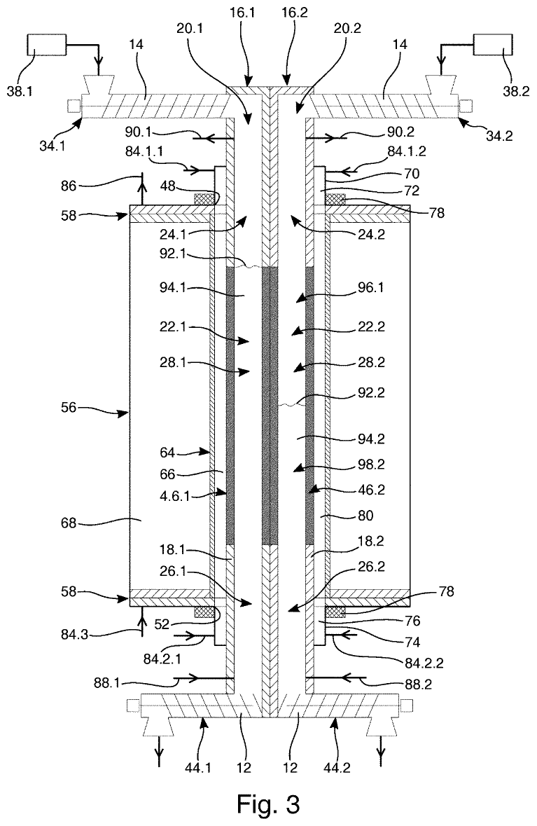

FIG. 3 shows a furnace 10 according to a second exemplary embodiment, in which two process tubes 16.1 and 16.2 extend through the insulating housing 56. This exemplary embodiment also illustrates further modifications in which more than two process tubes 56 are present and extend in a corresponding manner through the insulating housing 56.

In FIG. 3, not all components and constituent parts are provided with reference designations in the interest of simplicity; labeled components and constituent parts which correspond to the components and constituent parts in FIGS. 1 and 2 are provided with the same reference designations, the association with the first process tube 16.1 or with the second process tube 16.2 optionally being indicated by a corresponding index 0.1 or 0.2.

The protective housing 64 surrounds both process tubes 16.1, 16.2 here, but it is also possible for a separate protective housing 64 to be assigned to each process tube 16.1, 16.2.

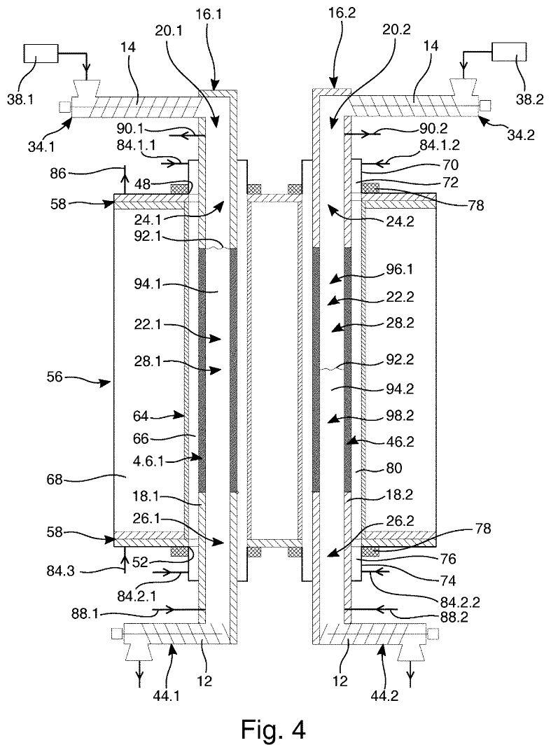

FIG. 3 also shows that the process tubes 16.1, 16.2 are in contact with one another; however, in one modification, which is illustrated in FIG. 4, the process tubes 16.1, 16.2 can also be at a distance from one another, so that carbon black is also arranged between the process tubes 16.1 and 16.2; the annular space 68 is appropriately modified. The surrounding housing and associated passages and openings are modified accordingly. There are therefore two protective housings 64 and annular spaces 66 present, and there are likewise two upper connection caps 70 and two lower connection caps 74, without all components occurring twice each bearing reference designations in the figure.

In the exemplary embodiment shown in FIG. 3, each process tube 16.1, 16.2 is assigned in each case a separate feed conveyor 34.1 and 34.2, respectively, and in each case a separate output conveyor 44.1 and 44.2, respectively. In one modification, there can also be only a single feed conveyor 34 present which supplies both process tubes 16.1, 16.2 with material. Accordingly, there can also be only a single output conveyor 44 present which takes up graphite 12 from both process tubes 16.1, 16.2 and discharges it.

When more than two process tubes 16 are present, a single feed conveyor 34 can supply only one, a pair or groups of three or more process tubes 16 and optionally all process tubes 16 with graphitizable material 14. In a corresponding way, in the case of more than two process tubes 16, a single output conveyor 44 can take up graphite 12 obtained from only one, a pair or groups of three or more process tubes 16 and optionally all process tubes 16 and discharge it.

When two process tubes 16.1, 16.2 are each assigned separate feed conveyors 34.1, 34.2 and separate output conveyors 44.1, 44.2, the process tubes 16.1, 16.2 can be supplied with different graphitizable materials 14 which require different residence times in the respective heating zone 28.1, 28.2 or a standing heating zone 98, with the latter being shown only in the form of the standing heating zone 98.2 in the case of process tube 16.2 in FIG. 3. This demonstrates that different process tubes 16.1, 16.2 can also be operated in different modes of operation.

Regardless of the total number of process tubes 16, the heating zones 28.1, 28.2 of two different process tubes 16.1, 16.2 can have equal or different lengths. When the process tubes 16.1, 16.2 are each operated with a falling heating zone 96, the lengths thereof and thus the respective length ratio of falling heating zone 96 to standing heating zone 98 can also be different.

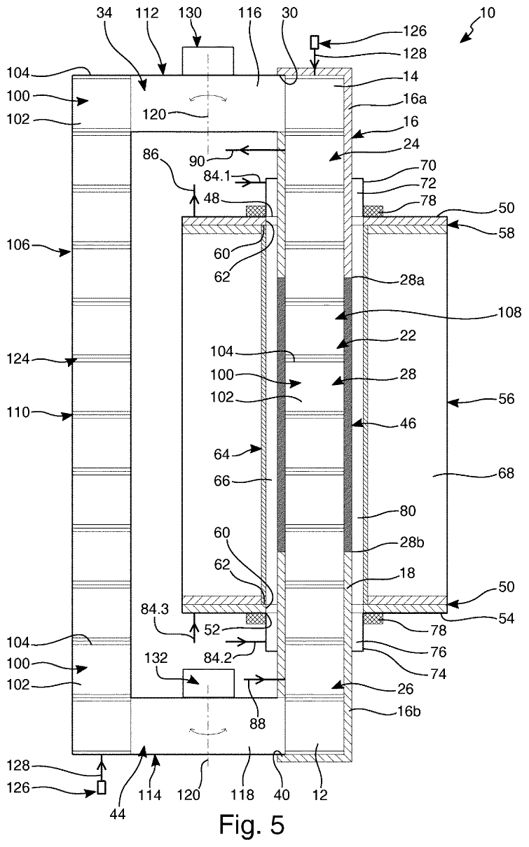

FIG. 5 illustrates a third exemplary embodiment of the furnace 10, in which the graphitizable material 14 is not introduced as such as bulk or flowable material into the process space 22, but instead is conveyed in a container 100 for material through the process space 22 and through the heating zone 28. As containers 100 for material, of which only three bear reference designations, crucibles 102 having a crucible lid 104 are provided in the present exemplary embodiment. A transport system 106 is configured in such a way that a carrier 100 for material filled with graphitizable material 14 can be conveyed along the path through the entrance 30 into the process space 22, from there through the process space 22 to the exit 40 and along the path through the exit 40 out of the process space 22.

For this purpose, the transport system 106 comprises the feed conveyor 34 and the output conveyor 44, which in this exemplary embodiment are configured in such a way that they convey containers 100 for material containing material. In addition, the transport system 106 comprises a process space conveyor 108 which is likewise configured in such a way that it conveys containers 100 for material containing material in the process space 22, and conveys the containers 100 for material from the entrance 30 to the exit 40.

In addition, the transport system 106 in the present exemplary embodiment is designed as loop transport system and for this purpose comprises a connecting conveyor 110, by means of which containers 100 for material can be conveyed from the output conveyor 44 to the feed conveyor 34.

The feed conveyor 34 and the output conveyor 44 are here designed as rotary conveyors 112 and 114 which each comprise a rotary element 116 and 118, respectively, which can be rotated around a respective vertical axis of rotation 120. The process space conveyor 108 and the connecting conveyor 110 are designed as linear conveyors 122 and 124, for which purpose a pushing device 126 having a powered pushing element 128, here in the form of a push rod, is present in each case. In the case of the process space conveyor 108, the pushing element 128 pushes a container 100 for material which has entered the process space 22 into the inlet zone 24. This container 100 for material then strikes against the container 100 for material located underneath, as a result of which all containers 100 for material present in the process space 22 are pushed one place further on. For this to function, a vacant position without a container 100 for material is present at the exit 40 of the process space 22 at this point in time.

When the containers 100 for material pass through the heating zone 28 on the path through the process space 22, the graphitizable material 14 is graphitized to give graphite 12. A container 100 for material at the exit 40 consequently contains graphite 12. When a container 100 for material has arrived at the exit 40 of the process tube 16, a vacant position is formed at the entrance 30, so that a container 100 for material laden with graphitizable material 14 can there be conveyed into the process space 22 by means of the feed conveyor 34. Here, at the end of the transport path of the connecting conveyor 110, a vacant position is produced on the feed conveyor 34 into which an empty container 100 for material is then pushed by means of the connecting conveyor 110 which operates in the same way as the process space conveyor 108. A vacant position which then arises at the entrance of the connecting conveyor 110 is filled with an empty container 100 for material by means of the output conveyor 44 when the latter takes the container 100 for material laden with graphite 12 from the process tube 16.

The feed conveyor 34 comprises a charging station 130 by means of which an empty container 100 for material can be filled with graphitizable material 14. The output conveyor 44 comprises an emptying station 132 by means of which graphite 12 can be taken from a container 100 for material. Suitable lock designs are employed here in order to prevent contamination of the furnace atmosphere with foreign atmosphere.

Under the circumstances illustrated in FIG. 5, the rotary elements 116 and 118 on four accommodation positions for containers 100 for material are designed so that a rotation by 900 about the axis of rotation 120 is performed in each step. The charging station 130 is reached in this case by an empty container 100 for material one step before the entrance 30 of the process tube 16, and the emptying station 132 is reached by a container 100 for material filled with graphite 12 one step after the exit 40 of the process tube 16.

In the process space 22, the containers 100 for material are consequently conveyed intermittently in the case of the furnace 10 described. In one modification and with a correspondingly designed transport system 106, the containers 100 for material can also be conveyed continuously in the process space 22.

In all the exemplary embodiments described above, the temperature in the heating zone 28 or the temperature of the column of material 94 is monitored by means of a temperature monitoring device.

For this purpose, the temperature is determined at the upper end 28a of the heating zone 28 and/or in approximately the middle of the heating zone 28 and/or at the lower end 28b of the heating zone 28 of each process tube 16 present.

As an alternative or in addition, a temperature measurement can also be made from above at the fill level 92 of the column of material 94.

The temperature measurements are preferably carried out using a pyrometer with a pyrometer tube, as is known per se, with the measuring end of the pyrometer tube being arranged at the respective measurement position. The measurement is preferably carried out at the side of the heating device 46.

For the measurement at the heating zone 28, the pyrometer tube runs, for example, from the outside through the outer wall of the insulating housing 56 and also through the insulating annular space 66 and through the wall of the protective housing 64 into the annular space 66 to before the outer tube wall 18 of the process tube 16. The associated pyrometer is positioned at the free end of the pyrometer tube on the outside of the protective housing 56. Corresponding pyrometer tubes are preferably arranged horizontally. From the temperature determined in this way on the outside of the process tube, the temperature can

If a measurement is to be carried out at the top at the fill level 92 of the column of material 94, a pyrometer tube extends from above into the process tube 16 to just above the fill level 92. The pyrometer tube then preferably runs vertically and the pyrometer is correspondingly arranged at the top on the pyrometer tube. However, a horizontal arrangement of the pyrometer tube is also possible. In this case, however, the pyrometer tube also penetrates through the outer tube wall 18 of the process tube 16 and opens into the process space 22.

What is claimed is:

1. A vertical graphitization furnace having at least one process space which delimits a heating zone, comprising:
a) a heating device by means of which a temperature of from 2200° C. to 3200° C. can be generated in the heating zone;
b) a feed conveyor by means of which particulate graphitizable material can be fed through an entrance into the process space;
where
c) graphitizable material can be conveyed through the heating zone of the process space, in which it is graphitized to give graphite;
d) an output conveyor is present, by means of which graphite obtained can be discharged from the process space through an exit;
wherein
e) the heating zone in at least one process space comprises a falling heating zone and a standing heating zone which are configured such that a column of material is formed in the standing heating zone and graphitizable material which has been fed in through the entrance can trickle from the top through the falling heating zone onto the column of material;
and/or
f) a transport system is present, by means of which graphitizable material can be conveyed in one or more containers for material through at least one process space and through the heating zone thereof.

2. The vertical graphitization furnace as claimed in claim 1, wherein the feed conveyor and the output conveyor are configured in such a way that they convey containers for material containing material, and the transport system comprises a process space conveyor which is configured in such a way that it conveys containers for material from the entrance to the exit.

3. The vertical graphitization furnace as claimed in claim 2, wherein the transport system is a loop transport system and comprises a connecting conveyor by means of which containers for material can be conveyed from the output conveyor to the feed conveyor.

4. The vertical graphitization furnace as claimed in claim 1, wherein the containers for material are crucibles having a crucible lid.

5. The vertical graphitization furnace as claimed in claim 1, wherein a plurality of process spaces are present.

6. The vertical graphitization furnace as claimed in claim 1, wherein the temperature generated in the heating zone is 3000° C.
